(19) United States
(12) Patent Application Publication
(10) Pub. No.: US 2008/0007398 A1
(43) Pub. Date: Jan. 10, 2008

(54) System and method for tracking assets

(75) Inventors: Lynn DeRose, Gloversville, NY (US); Roman Brusilovsky, Clifton Park, NY (US); Brandon Stephen Good, Brainard, NY (US); Pratima Rangarajan, Irvine, CA (US); Aaron Shaw Markham, Pasadena, CA (US); Russell Robert Irving, Ballston Lake, NY (US); Joseph James Salvo, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/480,652

(22) Filed: Jul. 5, 2006

(51) Int. Cl. G08B 1/08; H04Q 7/00

(52) U.S. Cl. 340/539.13

(57) ABSTRACT

A technique is provided for wirelessly tracking valuable assets during transit via a tracking system. The tracking system includes an event sensor for generating a trigger signal upon sensing an event and a position sensing device for receiving positional information of an asset being tracked. The tracking system also includes a communication device for communicating a date, a time and received positional information to one or more monitoring stations upon being triggered by the trigger signal. The one or more monitoring stations process the information received from the tracking system to determine if the event is expected or an anomaly via an anomaly detection algorithm.

### BACKGROUND

The invention relates generally to tracking of assets, and more specifically to wireless tracking of valuable assets during distribution or transit to monitor their movement and handling.

A wide variety of valuable assets are delivered globally and are often lost, misplaced, or stolen during transit or distribution. Such mishandling of valuable assets during transit or distribution is undesirable and may have significant economic impact. The stolen assets may be sold directly or indirectly leading to loss in revenues to the supplier of the assets. For example, in the area of consumer goods distribution, as high value assets such as large screen TVs, are delivered for distribution, they may be intercepted and sold in the black market. Similarly, assets such as packages containing sensitive and confidential documents may be intercepted and copies may be made of the documents for being sold or passed to undesired parties.

The current techniques of securing assets during transit and/or distribution depend primarily upon placing a seal or lock and verifying the integrity of contents and absence of tampering by inspecting the seal. For example, some cases or packages currently have a serialized lock that must be opened with bolt cutters at the receiving end. Additionally, each case may be sealed with tamper-proof stickers. The sticker will indicate tampering if the, case has been opened. However, the above technique is of limited value since it is not possible to track when and where in the delivery process the case is compromised. Present techniques are therefore not very effective in tracking theft of the high value asset. The need for security during transit or distribution requires not only proof that integrity of the asset was maintained but also requires monitoring and tracking of the assets to identify critical leaks in distribution channels.

It is therefore desirable to provide an efficient and effective technique for monitoring and tracking the location of the asset during delivery and detecting if the asset has been compromised.

### SUMMARY

Briefly in accordance with an embodiment of the invention, a tracking system is provided. The tracking system includes an event sensor for generating a trigger signal upon sensing an event and a position sensing device for receiving positional information of an asset being tracked. The tracking system also includes a communication device for communicating information, including the received positional information, upon being triggered by the trigger signal.

In accordance with an aspect of the invention, a trackable asset is provided. The trackable asset includes an event sensor coupled to the trackable asset for generating a trigger signal on sensing an event and a position sensing device disposed within the trackable asset for receiving positional information of the trackable asset. The trackable asset also includes a communication device disposed within the trackable asset for communicating a date, a time and the received positional information to one or more monitoring stations upon being triggered by the trigger signal.

In accordance with a further aspect of the invention, a trackable asset is provided. The trackable asset includes an asset disposed within a case, an event sensor for generating a trigger signal upon removal of the asset from the case, and a position sensing device for receiving positional information of the case. The trackable asset also includes a communication device for communicating information, including the received positional information, upon being triggered by the trigger signal.

In accordance with an embodiment of the invention, a method is provided for tracking an asset. The method provides for generating a trigger signal upon sensing an event, receiving positional information of the asset, and communicating a date, a time and received positional information to one or more monitoring stations upon being triggered by the trigger signal. Systems and computer programs that afford functionality of the type defined by this method may also be provided by the present invention.

In accordance with an aspect of the invention, a method is provided for tracking an asset. The method provides for generating a trigger signal upon removal of the asset from a case, receiving positional information of the case, and communicating a date, a time and received positional information to one or more monitoring stations upon being triggered by the trigger signal. Systems and computer programs that afford functionality of the type defined by this method may also be provided by the present invention.

These and other advantages and features will be more readily understood from the following detailed description of preferred embodiments of the invention that is provided in connection with the accompanying drawings.

### BRIEF DESCRIPTION OF THE DRAWINGS

FIG. 1 depicts a block diagram of a tracking system in accordance with aspects of the invention.

FIG. 2 depicts a trackable asset comprising a RFID tag and a reader in accordance with aspects of the invention.

FIG. 3 depicts a trackable asset comprising a magnetic switch in accordance with aspects of the invention.

FIG. 4 depicts a trackable asset comprising a thin wire embedded in security tape wound around the case in accordance with aspects of the invention.

FIG. 5 depicts a schematic diagram of tracking the trackable asset in accordance with aspects of the invention.

### DETAILED DESCRIPTION OF EXEMPLARY EMBODIMENTS

Embodiments of the invention are generally directed to wireless tracking of valuable assets upon detecting events, such as theft or tampering, via a tracking system. Such tracking techniques may be useful in a variety of contexts, such as distribution of valuable goods, transit of cargo containers, delivery of courier packages or sensitive documents, and so forth. While descriptions herein provide examples in the context of asset distribution, one of ordinary skill in the art will readily apprehend the application of embodiments of the invention in other contexts, such as for delivery of packages or sensitive documents, is well within the scope of the invention.

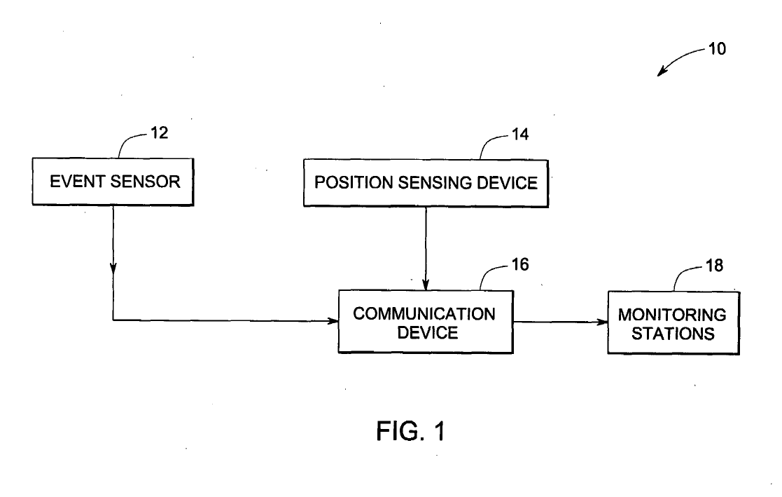

Referring now to FIG. 1, a block diagram of an exemplary tracking system 10 is illustrated. The tracking system 10 includes an event sensor 12 for generating a trigger signal on sensing an event and a position sensing or locating device 14 for receiving positional information of an asset being tracked. It should be noted that the position sensing device 14 may be adapted to track the location of the asset through out the transporting process. The exemplary tracking system 10 further includes a communication device 16 for communicating a date, a time and received positional information to one or more monitoring or tracking stations 18 upon being triggered by the trigger signal. In one embodiment, the monitoring may be performed at a centralized monitoring station. The one or more monitoring or tracking stations 18 process the location and time stamp information received from the communication device 16 to determine if the event is expected or an anomaly via an anomaly detection algorithm. An alarm or flag may be raised on detecting the anomaly.

As will be appreciated by one skilled in the art, a wide variety of event sensors may be employed by the tracking system 10 for detecting various events. For example, different event sensors may include a RFID tag and a reader, a magnetic switch, a wired electric circuit, and so forth. It should be noted that, in certain embodiments, one or more of the above event sensors may be employed by the tracking system 10 for detecting events such as theft or tampering of the asset, opening of the asset, breaking of the asset, and so forth. The position sensing (locating) device 14 may include one or more of a GPS-based position sensing device, a TV-based position sensing device, a TV-GPS based position sensing device, a wireless access point network-based position sensing device, or a GSM network-based position sensing device. These position sensing devices 14 utilize TV signals, GPS signals, GSM signals, or wireless network signals for receiving positional information of the asset being tracked. Further, as will be appreciated by one skilled in the art, the communication device 16 may include one or more of a GSM-based communication device, a GPRS-based communication device, a wireless communication device, or other devices known to one skilled in the art.

The tracking system 10 may be installed in and/or coupled to a wide variety of assets, such as cargo containers, packages, pharmaceutical drug containers, sensitive documents, for tracking or monitoring the assets during transit. Such trackable assets may include an event sensor for generating a trigger signal on sensing an event and a position sensing device disposed within the trackable asset for receiving positional information of the trackable asset. The position sensing (locating) device 14 may be constantly acquiring location information of the asset. The trackable asset further includes a communication device 16 disposed within the trackable asset for communicating a date, a time and the received positional information to one or more monitoring stations upon being triggered by the trigger signal. In one embodiment, the event sensor is embedded in the trackable asset in a certain state such as a 1. When an event occurs, the state of the sensor changes to a 0. The change in state of the sensor triggers the communication device 16 to send the event trigger date and time as well as the location information of the asset to one or more monitoring stations 18.

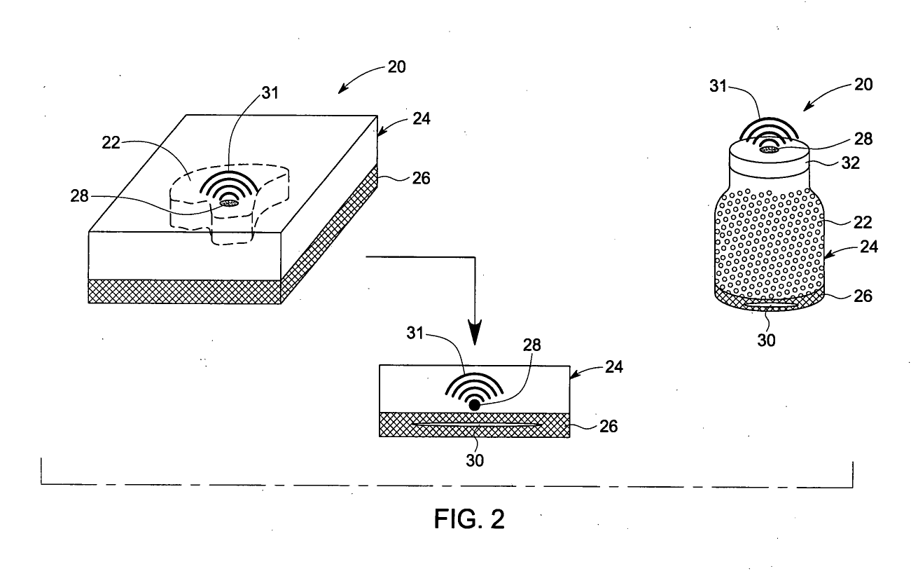

For example, various trackable assets 20 employing the tracking system 10 are illustrated in FIGS. 2-4 in accordance with aspects of the invention. The trackable asset 20 may include an asset 22, such as a pharmaceutical drug, placed within a case or a container 24. In certain embodiments, the case or the container 24 has a false bottom 26 for covertly holding the tracking system 10 so that the entire monitoring or tracking process may be covert and undetected by the outside world. The trackable asset 20 further includes one or more event sensors, such as those described above, for generating a trigger signal upon removal of the asset 22 from the case or the container 24 or upon breaking the case or the container 24. As will be appreciated by one skilled in the art, a wide variety of event sensors may be employed by the trackable asset 20 to generate the trigger signals as described in greater detail below.

In the embodiment illustrated in FIG. 2, the event sensor includes a RFID tag 28 and a reader 30. The RFID tag 28 is embedded within the asset 22 for generating radiofrequency (RF) signals 31. Alternatively, the RFID tag 28 may be embedded within the lid 32 of the container 24. The RFID reader 30 is disposed within the case or the container 24 for continuously receiving the RF signals 31 from the RFID tag 28. The RFID reader 30 generates the trigger signal upon non-receipt of the RF signals 31, which occurs when the two entities are not in proximity to each other (upon removal of the asset 22 from the case 24 or upon removal of the lid 32 from the container 24). In one embodiment, the trigger signal is generated when the RFID tag 28 and the reader 30 are no longer within a couple of inches of each other. Further, as will be appreciated by one skilled in the art, in one embodiment, the RFID reader 30 may be disposed within a false bottom 26 of the case or the container 24. Alternatively, the RFID reader 30 may be disposed within a false bottom of the lid 32 of the container 24.

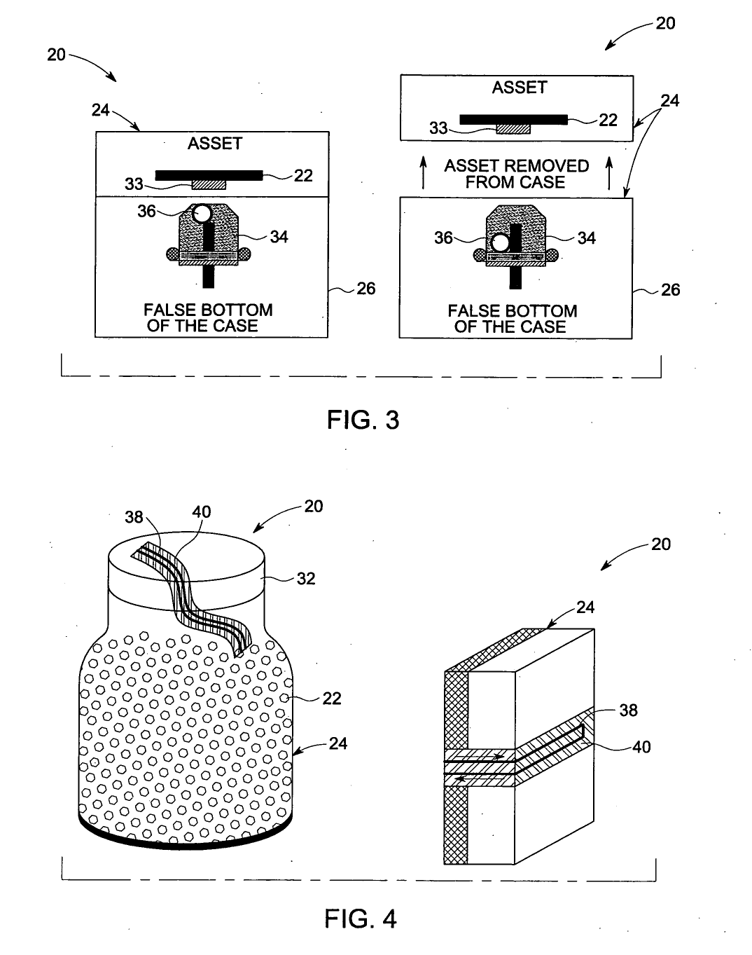

Similarly, in the embodiment illustrated in FIG. 3, the event sensor includes a magnetic switch. The magnetic switch includes a magnet 33 embedded within the asset 22 or within the lid 32 of the container 24. The magnetic switch further includes a switch 34 with a ball 36 disposed within the case or the container 24. The magnet 33 holds the ball 36 on top of the switch 34 and the trigger signal is generated when the ball 36 is out of range of magnetic field of the magnet 33 upon removal of the asset 22 from the case 24 or upon removal of the lid 32 from the container 24. It should be noted that, in one embodiment, the switch 34 with the ball 36 may be placed within the false bottom 26 of the case or the container 24 or within a false bottom of the lid 32.

In an alternative embodiment illustrated in FIG. 4, the event sensor includes a thin wire 38 embedded within a security tape 40 wound around the case or across the lid 32 of the container 24 and a current sensor (not shown) disposed within the case or the container 24 for sensing a flow of current in the thin wire 38. The current sensor generates the trigger signal on detecting a discontinuity in the flow of current within a thin wire 38 due to breaking of the thin wire 38. The thin wire 38 may break upon cutting or tampering of the security tape 40. It should be noted that, in one embodiment, the current sensor may be placed within the false bottom 30 of the case or the container 24 or within a false bottom of the lid 32.

The trackable asset 20, described in the various embodiments above, further includes a position sensing device for receiving positional information of the case or the container and a communication device for communicating a date, a time and received positional information to one or more monitoring stations upon being triggered by the trigger signal. The position sensing device and the communication device may be disposed within the case or the container 24. As will be appreciated by one skilled in the art, in one embodiment, the position sensing device and the communication device may be disposed within a false bottom 30 of the case or the container 24 or within a false bottom of the lid 32 so that the tracking system is hidden from view.

It should be noted that any of the position sensing device or the communication device listed above may be employed in the illustrated embodiments. In one embodiment, a TV-GPS based position sensing device and a cellular or wireless communication device may be employed. As will be appreciated by one skilled in the art, the use of TV and GPS waves to triangulate position of the asset by the TV-GPS based position sensing device enables locating the asset indoors as well as outside of a premises.

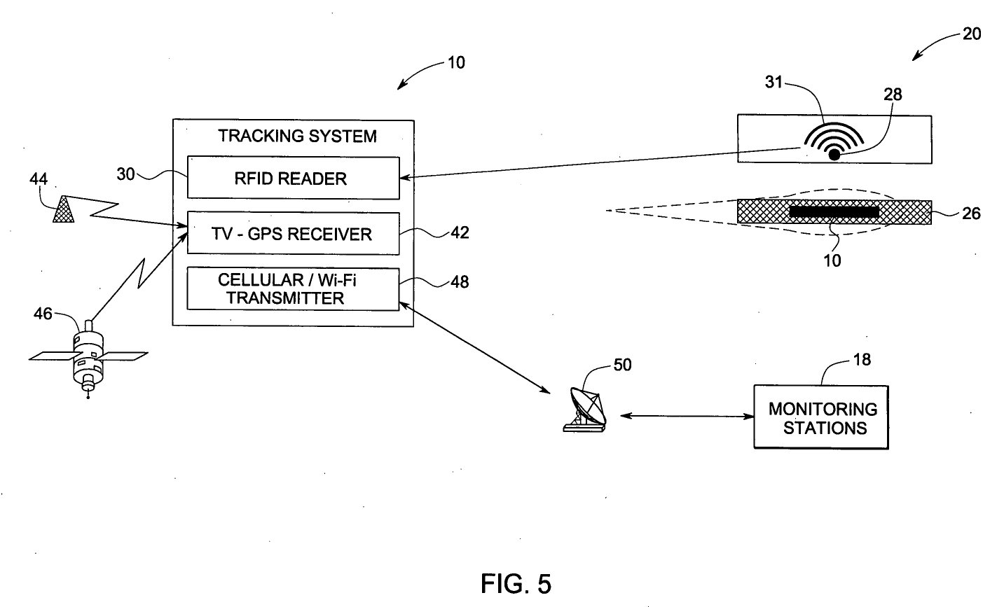

A schematic diagram of tracking the trackable asset 20 is illustrated in FIG. 5 in accordance with aspects of the invention. In the illustrated embodiment, a tracking system 10 may be disposed within the false bottom 26 of the trackable asset 20. The tracking system 10 employs a RFID tag 28 and a reader 30 as the event sensor. A TV-GPS based positioning device 42 is employed to gather the positional information of the asset 20 by utilizing TV signals from a local TV station 44 and/or GPS signals from a GPS satellite 46. Upon removal of the asset 22 from the case 24 or upon removal of the lid 32 from the container 24, the RFID reader 30 do not receive the RF signals 31 from the RFID tag 28 as the two entities are not in sufficient proximity to each other, and therefore generates the trigger signal. Upon being triggered by the trigger signal, a cellular or wireless transmitter 48 transmits date and time of the removal of the asset 22 from the case or the container 24 to one or more remote monitoring stations 18 over a satellite or wireless link 50 along with the received position information of the case or the container 24 at the time of removal of asset 22 from the case or the container 24. The one or more monitoring stations 18 processes the received information to determine if the removal of the asset 22 from the case or the container 24 is expected or an anomaly via an anomaly detection algorithm. An alarm or flag may be raised on detecting the anomaly.

In one specific example, a RFID embedded transponder is installed in an asset and a small receiver is installed in the case of the trackable asset. The transponder and receiver would trigger a GSM device to constantly dial a number with a TV-GPS device information. When the asset is removed from the case, the receiver stops seeing the transponder and the flow of information ceases with the database knowing the last date, time and location of the asset. The database would look at the event and determine, based on the business process rules, if the event is expected or if it is an anomaly and if someone should be notified.

As will be appreciated by one skilled in the art, a wide variety of assets, such as cargo containers, packages, pharmaceutical drugs, sensitive documents may be tracked via the techniques described herein. In certain embodiments, the tracking system 10 may be installed in false bottom of the cargo container, courier packages, jars, or packets of sensitive documents so as to track them in case of any tampering or theft.

The tracking system and techniques, described in the various embodiments discussed above, enables tracking valuable assets as they are shipped globally to determine the asset's location by employing integration of positioning technologies, communication technologies and event detection technologies. Further, the techniques described in various embodiments discussed above enable identifying shipping deviations if the courier is compromised and also provide the status, date, time and location of the compromised asset. Moreover, the use of TV-GPS based positioning device enables locating assets indoors or outside and does not require a line of sight to GPS satellites to transmit location. The business process rules and the anomaly detection algorithms keep the responsible end user from being inundated with useless information and only inform when an event is detected that calls for some sort of response. Additionally, the tracking device and transmitter is located on the asset itself and remains inconspicuous and undetectable by the outside world.

Further, as will be appreciated by one skilled in the art, the use of existing wireless communication technologies and tracking technologies to monitor the movements and handling of the valuable assets provides efficient and cost effective tracking techniques to reduce loss via theft or tampering and to identify critical leaks in the distribution channel. Moreover, the techniques, described in the various embodiments discussed above, support law enforcement investigations by sending time and location stamp information as an alert when the case or the container is opened in route.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. a tracking system, comprising:
an event sensor for generating a trigger signal upon sensing an event;
a position sensing device for receiving positional information of an asset being tracked; and
a communication device for communicating information comprising the received positional information upon being triggered by the trigger signal.

2. The tracking system of claim 1, wherein the information further comprises a date and a time of occurrence of the event.

3. The tracking system of claim 1, wherein the communication device communicates to one or more monitoring stations.

4. The tracking system of claim 3, wherein the one or more monitoring stations process the information to determine if the event is an anomaly via an anomaly detection algorithm.

5. The tracking system of claim 1, wherein the event sensor comprises at least one of a RFID tag and a reader, a magnetic switch, a wired electric circuit, or a combination thereof.

6. The tracking system of claim 1, wherein the event comprises at least one of tampering of the asset, opening of the asset, breaking of the asset, or a combination thereof.

7. The tracking system of claim 1, wherein the position sensing device comprises at least one of a GPS-based position sensing device, a TV-based position sensing device, a wireless access point network-based position sensing device, a GSM network-based position sensing device, or a combination thereof.

8. The tracking system of claim 1, wherein the position sensing device utilizes a TV signal, a GPS signal, a GSM signal, or a wireless network signal for receiving the positional information.

9. The tracking system of claim 1, wherein the communication device comprises at least one of a GSM-based communication device, a GPRS-based communication device, a wireless communication device, or a combination thereof.

10. The tracking system of claim 1, wherein the tracking system is coupled to the asset being tracked.

11. A trackable asset, comprising:
an event sensor coupled to the trackable asset for generating a trigger signal on sensing an event;
a position sensing device disposed within the trackable asset for receiving positional information of the trackable asset; and
a communication device disposed within the trackable asset for communicating a date, a time and the received positional information to one or more monitoring stations upon being triggered by the trigger signal.

12. A trackable asset, comprising:
an asset disposed within a case;
an event sensor for generating a trigger signal upon removal of the asset from the case;
a position sensing device for receiving positional information of the case; and
a communication device for communicating information comprising the received positional information upon being triggered by the trigger signal.

13. The trackable asset of claim 12, wherein the communication device further communicates a date and a time upon being triggered by the trigger signal.

14. The trackable asset of claim 12, wherein the case has a false bottom and the position sensing device is disposed within the false bottom.

15. The trackable asset of claim 12, wherein the case has a false bottom and the communication device is disposed within the false bottom.

16. The trackable asset of claim 12, wherein the communication device communicates to one or more monitoring stations.

17. The trackable asset of claim 16, wherein the one or more monitoring stations process the information to determine if the removal of the asset from the case is expected or an anomaly.

18. The trackable asset of claim 12, wherein the event sensor comprises a RFID tag embedded within the asset and a RFID reader disposed within the case for continuously receiving signals from the RFID tag and for generating the trigger signal upon non-receipt of the signals.

19. The trackable asset of claim 12, wherein the event sensor comprises a thin wire embedded within a security tape on the case and a current sensor disposed within the case for sensing a flow of current in the thin wire and for generating the trigger signal upon detecting a discontinuity in the flow of current.

20. The trackable asset of claim 12, wherein the event sensor comprises a magnet embedded within the asset and a switch with a ball disposed within the case, wherein the magnet holds the ball on top of the switch and the trigger signal is generated when the ball is out of range of magnetic field.

21. The trackable asset of claim 12, wherein the position sensing device: comprises at least one of a GPS-based position sensing device, a TV-based position sensing device, a wireless access point network-based position sensing device, a GSM network-based position sensing device, or a combination thereof.

22. The trackable asset of claim 12, wherein the communication device comprises at least one of a GSM-based communication device, a GPRS-based communication device, a wireless communication device, or a combination thereof.

23. A method of tracking an asset, the method comprising:
generating a trigger signal upon sensing an event;
receiving positional information of the asset; and
communicating a date, a time and received positional information to one or more monitoring stations upon being triggered by the trigger signal.

24. The method of claim 23, wherein said receiving positional information of the asset being tracked comprises utilizing a TV signal, a GPS signal, a GSM signal, or a wireless network signal for receiving positional information.

25. The method of claim 23, further comprising processing the date, the time and the received positional information to determine if the event is an anomaly via an anomaly detection algorithm.

26. The method of claim 25, further comprising generating an alarm on detecting the anomaly.

27. A method of tracking an asset, the method comprising:
generating a trigger signal upon removal of the asset from a case;
receiving positional information of the case; and
communicating a date, a time and received positional information to one or more monitoring stations upon being triggered by the trigger signal.

28. The method of claim 27, wherein said generating a trigger signal comprises generating the trigger signal upon non-receipt of signals from a RFID tag embedded within the asset by a RFID reader disposed within the case.

29. The method of claim 27, wherein said generating a trigger signal comprises generating the trigger signal when a current sensor disposed within the case detects a discontinuity in the flow of current within a thin wire embedded within a security tape on the case.

30. The method of claim 27, wherein said generating a trigger signal comprises generating the trigger signal when a ball on top of a switch disposed within the case is out of range of a magnetic field of a magnet embedded within the asset.

31. The method of claim 27, wherein said receiving positional information of the case comprises utilizing a TV signal, a GPS signal, a GSM signal, or a wireless network signal for receiving positional information.

32. The method of claim 27, further comprising processing the positional information to determine if the removal of the asset from the case is an anomaly via an anomaly detection algorithm.

33. The method of claim 32, further comprising generating an alarm on detecting the anomaly.
